(19) United States
(12) Patent Application Publication
(10) Pub. No.: US 2018/0349367 A1
(43) Pub. Date: Dec. 6, 2018

(54) SYSTEMS AND METHODS FOR ASSOCIATING VIRTUAL OBJECTS WITH ELECTRONIC DOCUMENTS, AND SEARCHING FOR A VIRTUAL OBJECT OR AN ELECTRONIC DOCUMENT BASED ON THE ASSOCIATION

(71) Applicant: Tsunami VR, Inc., Del Mar, CA (US)

(72) Inventor: Naresh SONI, San Diego, CA (US)

(21) Appl. No.: 15/996,501

(22) Filed: Jun. 3, 2018

Related U.S. Application Data
(60) Provisional application No. 62/515,546, filed on Jun. 6, 2017.
(60) Provisional application No. 62/518,545, filed on Jun. 12, 2017.
(60) Provisional application No. 62/521,481, filed on Jun. 18, 2017.

(51) Int. Cl. G06F 17/30; G06F 3/0482

(52) U.S. Cl. CPC G06F 17/30011; G06F 3/0482; G06F 3/017; G06F 17/30106; G06F 17/30091

(57) ABSTRACT

Associating virtual objects with electronic documents, and searching for a virtual object or an electronic document based on the association. Particular systems and methods determine metadata for a virtual object, generate a plurality of keywords for the metadata determined for the virtual object, determine if the plurality of keywords are associated with one or more electronic documents, and if any of the plurality of keywords are associated with the one or more electronic documents, index the one or more electronic documents and the virtual object in association with each other in a searchable index.

### TECHNICAL FIELD

This disclosure relates to virtual training, collaboration or other virtual technologies.

### BRIEF DESCRIPTION OF THE DRAWINGS

FIG. 1A and FIG. 1B depict aspects of a system on which different embodiments are implemented for associating virtual objects with electronic documents, and searching for a virtual object or an electronic document based on the association.

FIG. 2 depicts a method for associating virtual objects with electronic documents.

FIG. 3 depicts an embodiment for determining if a plurality of keywords are associated with one or more electronic documents.

FIG. 4 depicts an embodiment for using a searchable index to identify a virtual object associated with a selected electronic document.

FIG. 5 depicts an embodiment for using a searchable index to identify an electronic document associated with a selected virtual object.

FIG. 6 depicts an embodiment for using a searchable index to identify a virtual object associated with a keyword.

FIG. 7 depicts an embodiment for using a searchable index to identify an electronic document associated with a keyword.

FIG. 8 depicts a method for aggregating and packaging virtual content.

FIG. 9 is a block diagram of a method for searching and associating virtual content with other content.

FIG. 10 is a block diagram of a method for aggregating and packaging virtual content.

FIG. 11 depicts a method for creating an immersive sales module.

FIG. 12 is a block diagram of a method for creating an immersive sales module using virtual content.

FIG. 13 depicts a method for creating an immersive training module

### DETAILED DESCRIPTION

This disclosure relates to different approaches for associating virtual objects with electronic documents, and searching for a virtual object or an electronic document based on the association.

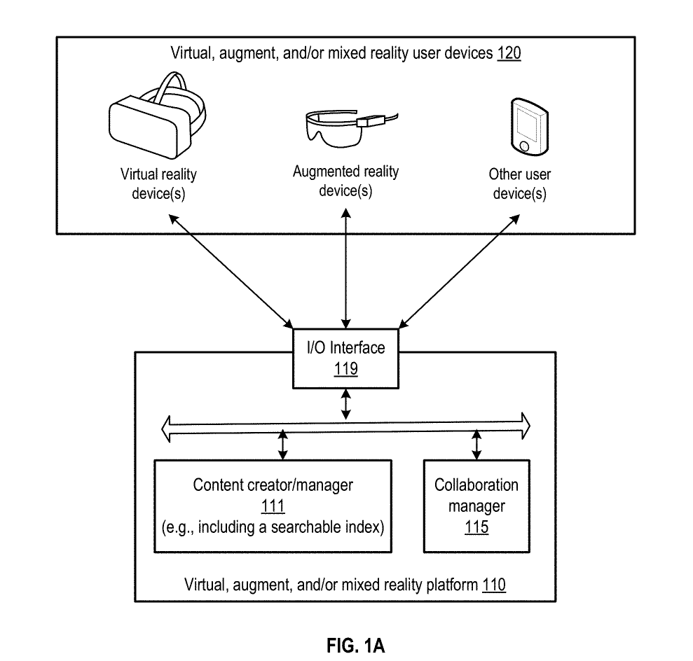

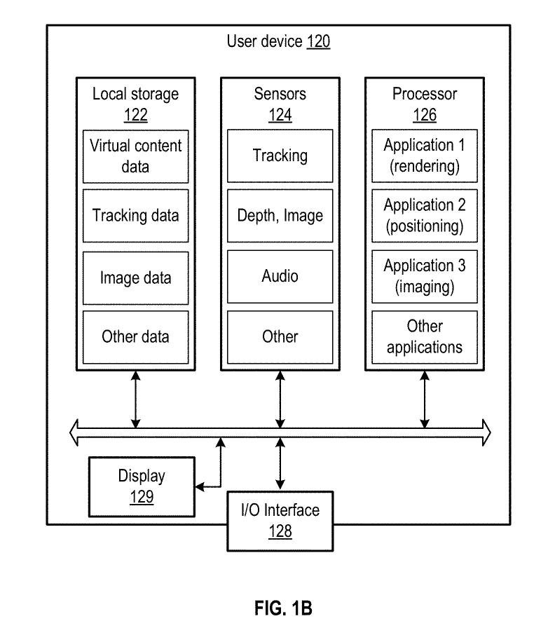

FIG. 1A and FIG. 1B depict aspects of a system on which different embodiments are implemented for associating virtual objects with electronic documents, and searching for a virtual object or an electronic document based on the association. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for associating virtual objects with electronic documents, and searching for a virtual object or an electronic document based on the association are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for associating virtual objects with electronic documents, and searching for a virtual object or an electronic document based on the association.

### Associating Virtual Objects with Electronic Documents, and Searching for a Virtual Object or an Electronic Document Based on the Association

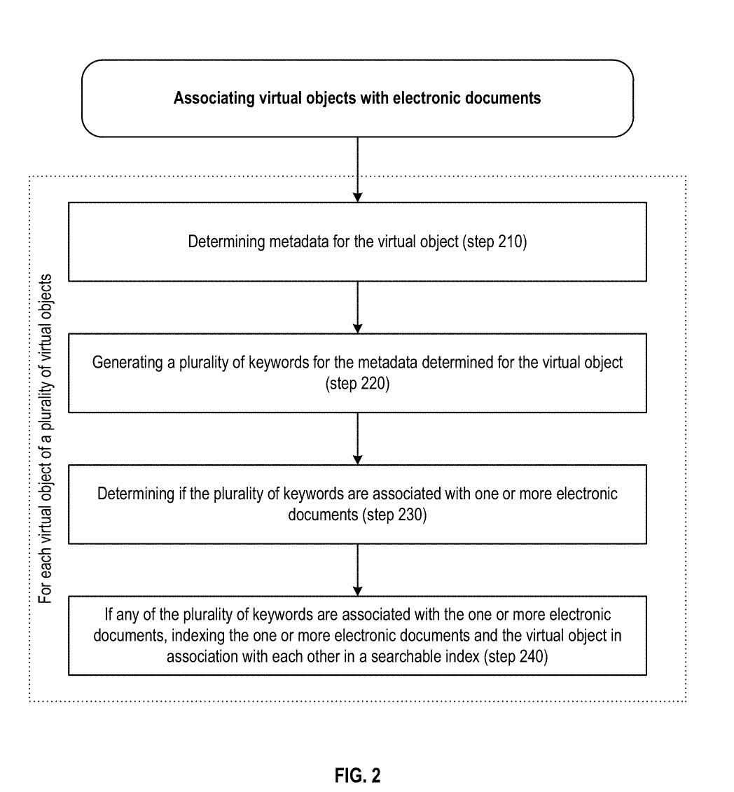

FIG. 2 depicts a method for associating virtual objects with electronic documents. The method depicted in FIG. 2 comprises, for each virtual object of a plurality of virtual objects: determining metadata for the virtual object (step 210); generating a plurality of keywords for the metadata determined for the virtual object (step 220); determining if the plurality of keywords are associated with one or more electronic documents (step 230); and if any of the plurality of keywords are associated with the one or more electronic documents, indexing the one or more electronic documents and the virtual object in association with each other in a searchable index (step 240).

In one embodiment of the method depicted in FIG. 2 or of any of the embodiments of FIG. 2 disclosed herein, the method further comprises: generating the searchable index to include, for each virtual object of the plurality of virtual objects, (i) the plurality of keywords generated from the metadata of the virtual object, (ii) associations between the keywords and the one or more electronic documents or associations between the keywords and the virtual object, and (iii) associations between the virtual object and the one or more electronic documents.

In one embodiment of the method depicted in FIG. 2 or of any of the embodiments of FIG. 2 disclosed herein, determining the metadata for the virtual object during step 210 comprises: using an automated program to collect the metadata from a file containing that virtual object.

In different embodiments of the method depicted in FIG. 2 or of any of the embodiments of FIG. 2 disclosed herein, the metadata for the virtual object includes any individual one or combination of the following types of metadata: an author or owner of the virtual object; a description, name or title of the virtual object; a date the virtual object was created; one or more words that represent one or more features of the virtual object; one or more images that form part of the virtual object; or one or more authors or owners of, descriptions of, names or titles of, or words that represent one or more features of one or more images that form part of the virtual object.

In different embodiments of the method depicted in FIG. 2 or of any of the embodiments of FIG. 2 disclosed herein, generating the plurality of keywords for the metadata during step 220 comprises generating as keywords any individual one or combination of the following types of keywords: a name of an author or owner of the virtual object that is specified in the metadata; words from a description of the virtual object that is specified in the metadata; words from a title or name of the virtual object that is specified in the metadata; one or more words representing one or more features of the virtual object that are specified in the metadata; a name of an author or owner of an image forming part of the virtual object that is specified in the metadata; words from a description of the image forming part of the virtual object that is specified in the metadata; words from a title or name of the image forming part of the virtual object that is specified in the metadata; or one or more words representing one or more features of the image forming part of the virtual object that is specified in the metadata.

In different embodiments of the method depicted in FIG. 2 or of any of the embodiments of FIG. 2 disclosed herein, the one or more electronic documents comprise a file with any of: text, an image, a CAD drawing, a table, a graph, a chart, a spreadsheet, a presentation, audio, or video.

In different embodiments of the method depicted in FIG. 2 or of any of the embodiments of FIG. 2 disclosed herein, the virtual object is a virtual reality object, an augmented reality object, or a mixed reality object.

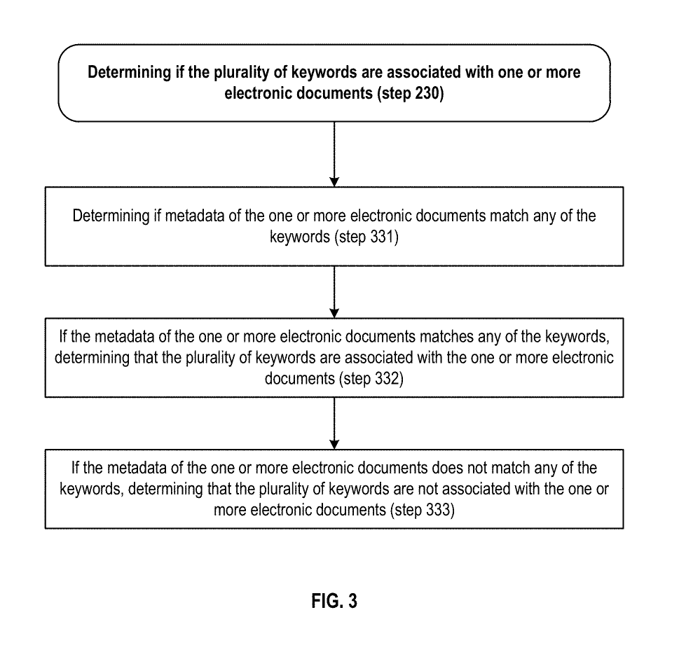

FIG. 3 depicts an embodiment for determining if the plurality of keywords are associated with one or more electronic documents during step 230 of FIG. 2. The embodiment shown in FIG. 3 comprises: determining if metadata of the one or more electronic documents match any of the keywords (step 331); if the metadata of the one or more electronic documents matches any of the keywords, determining that the plurality of keywords are associated with the one or more electronic documents (step 332); and if the metadata of the one or more electronic documents does not match any of the keywords, determining that the plurality of keywords are not associated with the one or more electronic documents (step 333). In one embodiment of FIG. 3, the plurality of keywords specify any of: a name of an author or owner of the virtual object; a description of the virtual object; a title or a name of the virtual object; or one or more words representing one or more features of the virtual object that are specified in the metadata of the virtual object.

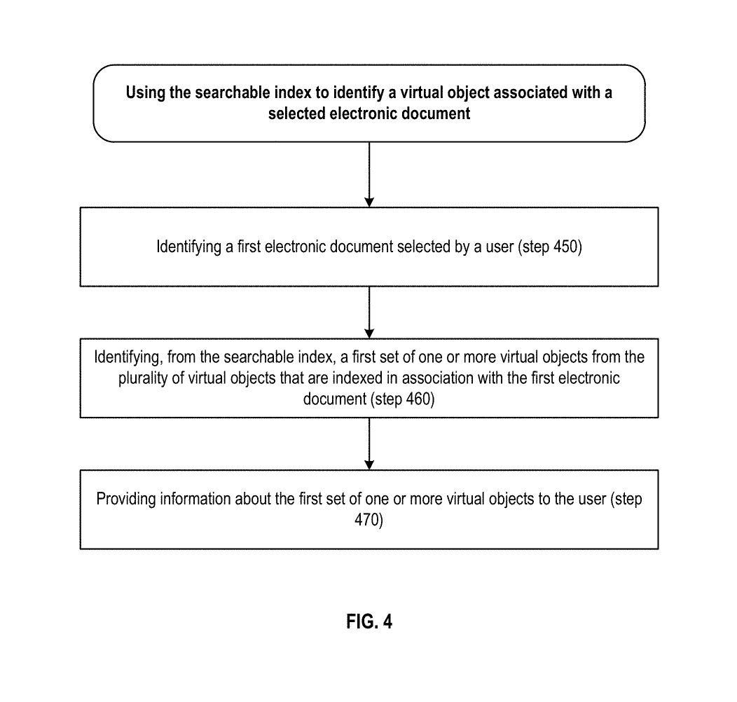

FIG. 4 depicts an embodiment of the method depicted in FIG. 2 with additional steps for using the searchable index to identify a virtual object associated with a selected electronic document, wherein the steps include: identifying a first electronic document selected by a user (step 450); identifying, from the searchable index, a first set of one or more virtual objects from the plurality of virtual objects that are indexed in association with the first electronic document (step 460); and providing information about the first set of one or more virtual objects to the user (step 470). In one embodiment of FIG. 4, the provided information includes a list of the first set of one or more virtual objects, and a list of any virtual objects associated with any of the first set of one or more virtual objects.

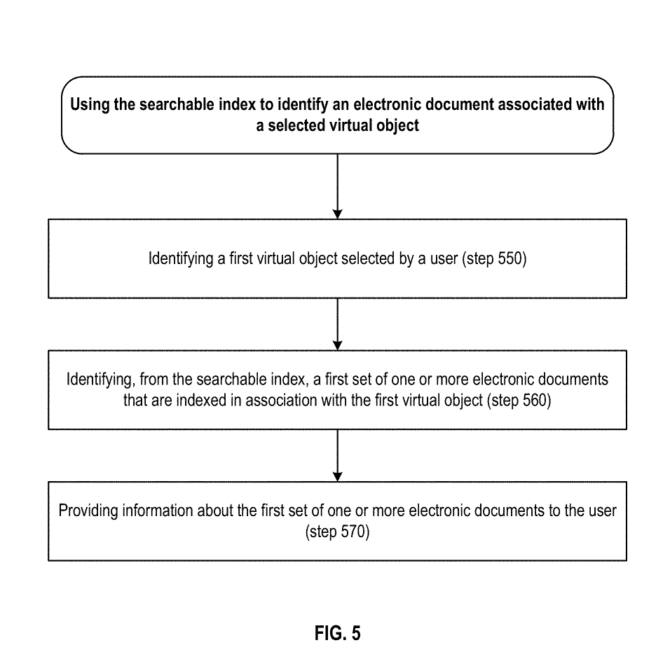

FIG. 5 depicts an embodiment of the method depicted in FIG. 2 with additional steps for using the searchable index to identify an electronic document associated with a selected virtual object, wherein the steps include: identifying a first virtual object selected by a user (step 550); identifying, from the searchable index, a first set of one or more electronic documents that are indexed in association with the first virtual object (step 560); and providing information about the first set of one or more electronic documents to the user (step 570). In one embodiment of FIG. 5, the provided information includes a list of the first set of one or more electronic documents.

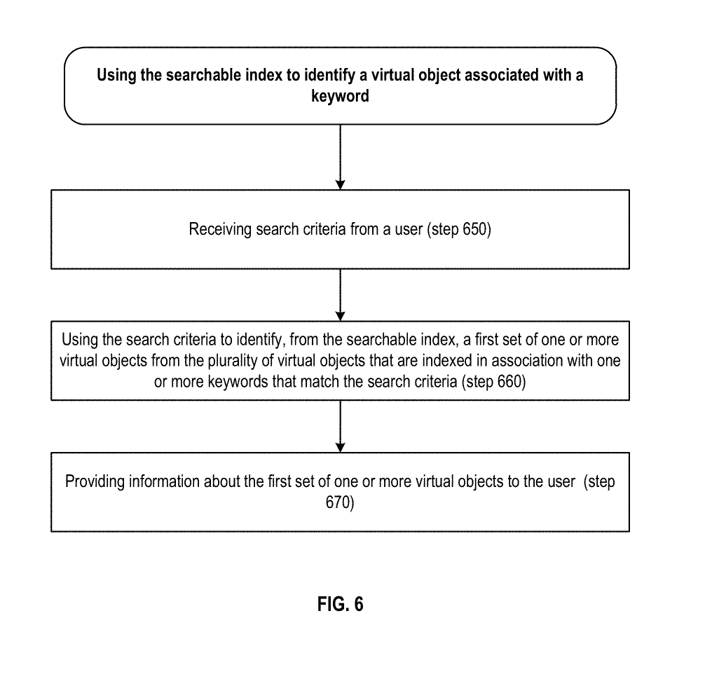

FIG. 6 depicts an embodiment of the method depicted in FIG. 2 with additional steps for using the searchable index to identify a virtual object associated with a keyword, wherein the steps include: receiving search criteria from a user (step 650); using the search criteria to identify, from the searchable index, a first set of one or more virtual objects from the plurality of virtual objects that are indexed in association with one or more keywords that match the search criteria (step 660); and providing information about the first set of one or more virtual objects to the user (step 670).

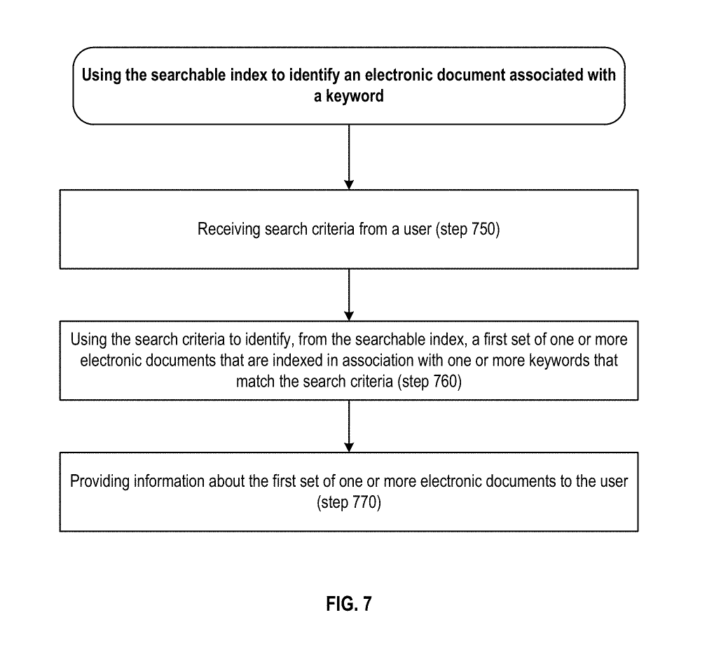

FIG. 7 depicts an embodiment of the method depicted in FIG. 2 with additional steps for using the searchable index to identify an electronic document associated with a keyword, wherein the steps include: receiving search criteria from a user (step 750); using the search criteria to identify, from the searchable index, a first set of one or more electronic documents that are indexed in association with one or more keywords that match the search criteria (step 760); and providing information about the first set of one or more electronic documents to the user (step 770).

Also contemplated are one or more non-transitory machine-readable media embodying program instructions that, when executed by one or more machines, cause the one or more machines to implement the method depicted in FIG. 2 or the methods of any of the embodiments of FIG. 2 disclosed herein.

Embodiments described above may be implemented with any virtual reality, augmented reality, or mixed reality virtual content in place of virtual object(s).

### Aggregating and Packaging Virtual Content

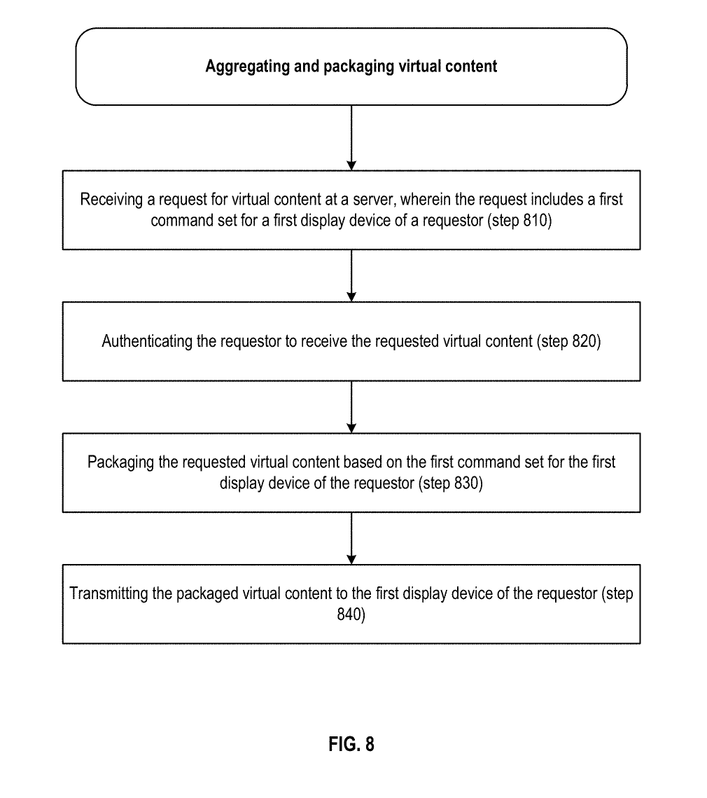

FIG. 8 depicts a method for aggregating and packaging virtual content. The method depicted in FIG. 8 comprises: receiving a request for virtual content at a server, wherein the request includes a first command set for a first display device of a first requestor (step 810); authenticating the first requestor to receive the requested virtual content (step 820); packaging the requested virtual content based on the first command set for the first display device of the first requestor (step 830); and transmitting the packaged virtual content to the first display device of the first requestor (step 840).

In one embodiment of the method depicted in FIG. 8 or of any of the embodiments of FIG. 8 disclosed herein, the first command set specifies a first security level of the first requestor, and the packaged virtual content includes an object with a first resolution or amount of scaling associated with the first security level of the first requestor. The method may further comprise: (i) receiving a second request for the virtual content at the server, wherein the second request includes a second command set for a second display device, wherein the second command set specifies a second security level of the second requestor; (ii) packaging, based on the second command set for the second display device, the virtual content to include the object with a second resolution or amount of scaling associated with the second security level of the second requestor; and (iii) transmitting, to the second display device, the packaged virtual content that includes the object with the second resolution or amount of scaling.

In one embodiment of the method depicted in FIG. 8 or of any of the embodiments of FIG. 8 disclosed herein, the first command set specifies a first security level of the first requestor, and the packaged virtual content includes a first object that is available to requestors with the first security level of the first requestor. The method may further comprise: (i) receiving a second request for the virtual content at the server, wherein the second request includes a second command set for a second display device, wherein the second command set specifies a second security level of the second requestor; (ii) packaging, based on the second command set for the second display device, the virtual content to not include the first object because the first object is not available to requestors with the second security level of the second requestor; and (iii) transmitting, to the second display device, the packaged virtual content that includes the object with the second resolution or amount of scaling.

In one embodiment of the method depicted in FIG. 8 or of any of the embodiments of FIG. 8 disclosed herein, the method further comprises: (i) receiving another request for other virtual content at the server, wherein the request includes a second command set for a second display device, wherein the first command set and the second command set are different; (ii) packaging the other virtual content based on the second command set for the second display device; and (iii) transmitting the other packaged virtual content to the second display device.

In one embodiment of the method depicted in FIG. 8 or of any of the embodiments of FIG. 8 disclosed herein, the packaged virtual content includes a first version of the virtual content, and the method further comprises: (i) receiving a second request for the virtual content at the server, wherein the second request includes a second command set for a second display device, wherein the first command set and the second command set are different; (ii) packaging a second version of the virtual content based on the second command set for the second display device; and (iii) transmitting the packaged second version of the virtual content to the second display device. In one implementation, the first version of the virtual content includes a first resolution or a first size of the virtual content that is identified based on the first command set, and the second version of the virtual content includes a second resolution or a second size of the virtual content that is identified based on the second command set. In one implementation, wherein the first command set specifies a first display capability of the first display device that allows the first resolution or the first size, and the second command set specifies a second display capability of the second display device that allows the second resolution or the second size.

In one embodiment of the method depicted in FIG. 8 or of any of the embodiments of FIG. 8 disclosed herein, authenticating the first requestor comprises: determining that the first requestor is permitted to access the requested virtual content, wherein the packaging and the transmitting are performed only if the first requestor is permitted to access the requested virtual content.

In one embodiment of the method depicted in FIG. 8 or of any of the embodiments of FIG. 8 disclosed herein, the method further comprises: (i) determining if the requested virtual content exists in a cache; and (ii) if the requested virtual content exists in the cache, packaging the virtual content comprises accessing the virtual content from the cache, wherein the virtual content from the cache is transmitted as the packaged virtual content. The method may further comprise: if the requested virtual content does not exist in the cache, accessing the virtual content from two or more storage locations, combining the accessed virtual content into a package of content, storing the package of content in the cache, and transmitting the package of content as the packaged virtual content.

In one embodiment of the method depicted in FIG. 8 or of any of the embodiments of FIG. 8 disclosed herein, the method further comprises: (i) generating the request for the virtual content at the first display device; and (ii) transmitting the request for the virtual content from the first display device to the server, wherein the request for the virtual content is received from the first display device over a network connection.

In one embodiment of the method depicted in FIG. 8 or of any of the embodiments of FIG. 8 disclosed herein, the packaged virtual content is transmitted to a client device before the client device transmits the packaged virtual content to the first display device. The method may further comprise: (i) generating the request for the virtual content at the client device; and (ii) transmitting the request for the virtual content from the client device to the server, wherein the request for the virtual content is received from the client device over a network connection.

In one embodiment of the method depicted in FIG. 8 or of any of the embodiments of FIG. 8 disclosed herein, the virtual content includes a CAD drawing or a three-dimensional object. In one embodiment of the method depicted in FIG. 8 or of any of the embodiments of FIG. 8 disclosed herein, the virtual content includes a virtual reality object, an augmented reality object, or a mixed reality object.

In one embodiment of the method depicted in FIG. 8 or of any of the embodiments of FIG. 8 disclosed herein, the first display device includes a virtual reality, augmented reality or mixed reality computing device (e.g., handheld phone, head mounted display, or other).

One or more non-transitory machine-readable media embodying program instructions that, when executed by one or more machines, cause the one or more machines to implement any of the above-described methods are also contemplated

### Embodiments Relating to Searching and Associating Virtual Content with Other Content

One purpose of certain embodiments of this section is to provide capability to search VR, AR or MR content and associate the content with documents, such as Excel, PowerPoint, Word, Notes, and others.

One embodiment includes a method for searching and associating virtual reality (“VR”) content with documents. The method includes scanning a plurality of VR content to generate metadata. The method also includes generating a plurality of keywords for the metadata for each of the plurality of VR content. The method also includes associating the plurality of keywords with a plurality of documents. The method also includes indexing the plurality of documents to the plurality of VR content to create a searchable index.

Yet another embodiment includes a method for searching and associating augment reality (“AR”) content with documents. The method includes scanning a plurality of AR content to generate metadata. The method also includes generating a plurality of keywords for the metadata for each of the plurality of AR content. The method also includes associating the plurality of keywords with a plurality of documents. The method also includes indexing the plurality of documents to the plurality of AR content to create a searchable index.

Yet another embodiment includes a method for searching and associating mixed reality (“MR”) content with documents. The method includes scanning a plurality of MR content to generate metadata. The method also includes generating a plurality of keywords for the metadata for each of the plurality of MR content. The method also includes associating the plurality of keywords with a plurality of documents. The method also includes indexing the plurality of documents to the plurality of MR content to create a searchable index.

The plurality of documents preferably comprise at least one of an EXCEL document, a POWERPOINT document, a WORD document, and a NOTE document.

In one embodiment, the method further comprises searching the index for a virtual object (e.g., an object that is displayable in virtual reality, augmented reality, or mixed reality).

In one embodiment, the method further comprises authenticating the user to search the index for a virtual object.

In one embodiment, the plurality of VR, AR or MR content comprise at least one of a CAD drawing, a component 3D object file, and a complete object file.

In one system for searching and associating virtual reality (“VR”) content with documents, the system comprising a collaboration manager at a server; and a database comprising a plurality of VR content. The collaboration manager is configured to scan the plurality of VR content to generate metadata. The collaboration manager is configured to generate a plurality of keywords for the metadata for each of the plurality of VR content. The collaboration manager is configured to associate the plurality of keywords with a plurality of documents. The collaboration manager is configured to index the plurality of documents to the plurality of VR content to create a searchable index.

In another system for searching and associating augmented reality (“AR”) content with documents, the system comprising a collaboration manager at a server; and a database comprising a plurality of AR content. The collaboration manager is configured to scan the plurality of AR content to generate metadata. The collaboration manager is configured to generate a plurality of keywords for the metadata for each of the plurality of AR content. The collaboration manager is configured to associate the plurality of keywords with a plurality of documents. The collaboration manager is configured to index the plurality of documents to the plurality of AR content to create a searchable index.

In yet another system for searching and associating mixed reality (“MR”) content with documents, the system comprising a collaboration manager at a server; and a database comprising a plurality of MR content. The collaboration manager is configured to scan the plurality of MR content to generate metadata. The collaboration manager is configured to generate a plurality of keywords for the metadata for each of the plurality of MR content. The collaboration manager is configured to associate the plurality of keywords with a plurality of documents. The collaboration manager is configured to index the plurality of documents to the plurality of MR content to create a searchable index.

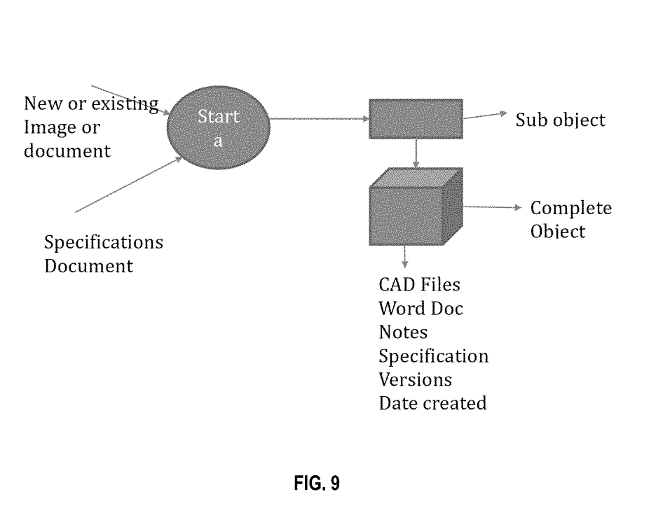

FIG. 9 is a block diagram of a method for searching and associating virtual content with other content.

Certain embodiments of this section enable developers, users, administrators to search specific content. This content can be CAD drawings, component 3D object files or a complete object (e.g., an aircraft engine, parts that constitute an aircraft engine or complete aircraft).

Certain embodiments of this section make it easy for developers to create an object or set of objects or complete objects using this search.

Before creating a new object, a search if the object or parts of objects exist in the cloud. How the object is being used? Link specifications of the object to actual inventory of objects. This will enable sales and project managers to estimate work.

Certain embodiments of this section extract metadata from video, images, and documents. Then it creates keywords from the metadata. It associates these keywords to documents, presentations and spreadsheets. It scales this to larger library of objects and the library grows.

Certain embodiments of this section allow for the reuse of objects or parts of objects. Automatically associating these objects with the documents through a search function, which enables to either reuse or have example objects to form the basis.

Certain embodiments of this section reduce the amount of work to be done to develop, estimate and create documentation.

When you have a large library of objects, there is an index of the objects or visual, the developers have to use and go by the index, where all the features of the objects are not available.

Certain embodiments of this section reduce the amount of work to create parts or full objects and also reduce the guess-work that can happen in estimating object creation.

In one embodiment, a video file, image, CAD drawing, photo is scanned through a tool creates metadata and keywords that are associated with these files. The metadata file is then associated with a given object. Several objects are scanned and a master metadata file is created for all the objects. An index for this metadata file is created. This index is used to do a quick search. A metadata is created for any documents that are associated with these objects (can be manuals, description of the objects, etc.). Using tool for associating metadata, these objects are associated with documents. When a person scans a proposal, the tool will do the association and provide a list of objects that is associated. If it is part of a larger object, it will provide the list of the larger object association. When a person is trying to create an object, they will do a search for the object. If they find an object or association, they will reuse or create a new object. If a person is trying to find a document related to an object, they will do a search and find the document. The search function will be tracked via tracking software. The person's ability to do a specific search will be designated by the administrator, i.e., if the person is authorized for that project and within that project they are designated to view, edit and retrieve the object. It is important to ensure that this operation is secured. Once a search is completed, the search results are presented.

The search results are presented as: Object type—2D, 3D, shape, dimensions, the parent of the object and its hierarchy; Creation of the object date, name of the creator, where it is used; Materials for the object, surface, color; and Document association—manuals, PowerPoint, excel files.

The above information is shown based on the role of the person searching for the object.

Search statistics for these objects are recorded: the date the query was made, who made the query, and the information that was retrieved.

In a preferred embodiment, the elements of the system include the cloud based server; a client device; a display device; tools for creating metadata; a network—wireless or wireline, a database; and documents—powerpoint, word documents, excel, notes, keynote, and CAD drawings.

The client device is preferably a personal computer, laptop computer, tablet computer or mobile computing device such as a smartphone.

The display device is preferably selected from the group comprising a desktop computer, a laptop computer, a tablet computer, a mobile phone, an AR headset, and a virtual reality (VR) headset.

Scanning video, photo, image, web content (html, xml). Scan for metadata.

Authentication. Authorize user to enable and different levels of scanning. A user can be authorized depending on his/her security level to search only certain types of projects and documents.

Create a log for this search. Log the date, search query, object or document viewed or retrieved.

Retrieve the object for a certain task. Based on user's security clearance level, a user is given authorization to retrieve for viewing, editing, storing an edited object. Associate documents or web pages to this object. Show the hierarchy of the object. The hierarchy of the object shows how the object is used. Show statistics, such as, who created this object, what project used it, date of creation, version of objects, associated documents. Statistics, revision and versions helps how the object and which version of the object is used. The association shows the usage and documents associated with the objects.

A search object library for a given object allows for reuse of objects or components of objects that are already present in the library.

If components of the objects are present, the system reuses the components of the object and creates a new object. If the object is present and some revisions are required, the system revises the object and if the object is present and used as is, the user can reuse the object as is. The search results will display hierarchy of the object, revisions or sub objects if present in the library. The user picks either a sub object, one of the revisions of the object or object displayed as is. The search results will be based on the security clearance of the user and will display appropriate information. The search results will also display documents associated with that object.

Based on user's security clearance, they will be able to retrieve the object to edit with option to lock other users from editing or retrieve the object. The user will pick appropriate objects based on the revision and the object that is being created. The user can also pick appropriate documents associated with that object (manuals, specifications, CAD drawings, etc.).

A user will create an object or revise objects or use objects within a larger object. One embodiment creates a document associated with that object or automatically associate document and object.

In one example, the input is a search object, and the output is a list of objects, hierarchy of objects, documents, CAD files associated with objects, revision and history of objects/documents.

In one example, the input is a search document, and the output is documents, CAD files and associated objects.

### Embodiments Relating to Aggregating and Packaging Virtual Content

In other approaches, when a user requests appropriate version of the object sequentially, the user has to know type of resolution, quality and associated objects, such as, images, photos, 2D and 3D objects.

There is a need for aggregating and packaging virtual (e.g., AR, VR, or MR) content.

One purpose of certain embodiments of this section is to reduce the bandwidth, and make the adaptation of content scalable and secured to supported devices. Certain embodiments reduce the bandwidth for requested virtual content from a cloud computing service to a requesting device. Certain embodiments automatically adapt to the requested device that is to be supported, and are scalable.

One embodiment includes a method for aggregating and packaging VR content. The method includes requesting a VR content from a collaboration manager. The collaboration manager resides at a server, and the request comprises a command set for a display device of a requestor. The method also includes authenticating the requestor for the requested VR content. The method also includes packaging the requested VR content based on the command set for the display device of the requestor. The method also includes transmitting the packaged VR content to the display device of the requestor.

Another embodiment includes a method for aggregating and packaging AR content. The method includes requesting an AR content from a collaboration manager. The collaboration manager resides at a server, and the request comprises a command set for a display device of a requestor. The method also includes authenticating the requestor for the requested AR content. The method also includes packaging the requested AR content based on the command set for the display device of the requestor. The method also includes transmitting the packaged AR content to the display device of the requestor.

Another embodiment includes a method for aggregating and packaging MR content. The method includes requesting an MR content from a collaboration manager. The collaboration manager resides at a server, and the request comprises a command set for a display device of a requestor. The method also includes authenticating the requestor for the requested MR content. The method also includes packaging the requested MR content based on the command set for the display device of the requestor. The method also includes transmitting the packaged MR content to the display device of the requestor.

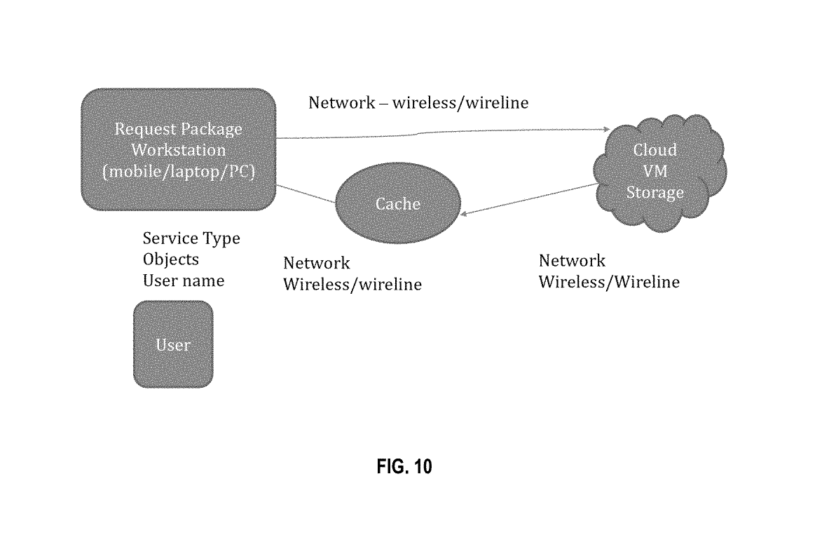

FIG. 10 is a block diagram of a method for aggregating and packaging virtual content.

Developing a complete immersive service, requires different types of content, which includes photos, videos, 3D pre-rendered objects (high quality, higher resolution, lower resolution, different texture types), 2D objects, documents (CAD files, manuals, specifications, design documents). These services are used for sales, marketing, training, engineering, design, collaboration, maintenance and repair. Combining different content types represent several challenges when you are using them in the scenes. This content has to be curated to enable search, retrieval, archive, index, reuse, attach metadata, specific instructions in graphics, voice. This content comes in different formats. Ability to ingest different types of contents in different formats and package them to accelerate creation of story, scenes or a service and also reduce storage. The content has to be made for different device types that needs to be supported (e.g., HTC Vive, Microsoft Hololens, Occulus, mobile device, laptops, desktop, tablets).

In one embodiment, a system requests content with command set with appropriate resolution and resolution. The system packages content to accelerate service development. The system reduces the amount of bandwidth required to transmit the requested virtual content. The system has the ability to support different content (pre-rendered, high resolution, high quality, minimum resolution, low resolution) and in different formats. Some of the content is adapted based on type of service requested on a device, the image gets resized, resolutions are adjusted. The system is scalable to larger library of objects and the library grows. The content is cached at different locations based on caching policy. The content is organized based on device profile for which the content is being developed.

A user requests a service with appropriate command to cloud. The cloud Virtual Machine (VM) authenticates the user. The VM checks if the content to be delivered to the user exists in the cache, if it exists in cache, the user get the content from cache, if not, it gets the content from the cloud VM and also depending on the caching policy, it also sends it to the cache. The content that is pacakged is personalized (resolution, pre-rendered, images/photos/2D/3D objects appropriately scaled) based on user's role and it's security clearance level. Hence, the user gets a complete package and can develop a service rapidly and efficiently.

The general elements of one embodiment include a cloud computing service; a PC, workstation, tablet, or smartphone; a display; a wireless or wireline network connection among the other elements; a database; and content (e.g., objects, images, photos, 2D/3D rendered).

In a system for aggregating and packaging virtual content, a cloud VM authenticates a requestor/user. Based on level of user's level of security clearance, appropriate content is authorized. The VM checks if the content exists in cache. If the content is in cache, the content is retrieved from cache if not the content is packaged from appropriate folders or prepared, packaged and sent to cache (based on caching policy) and then sent to the user. The user receives packaged content from either cache or from cloud server. Majority of time (generally, cache efficiency is higher than 80%), the content comes from cache and hence it reduces the amount of bandwidth.

An appropriate package is sent to the user. Based on the user and the command, the VM sends appropriate package of content to the user, so the user does not have to send several commands and wait. User will reduce the amount of time it takes to develop a complete service. Also, if the package exists in cache, it will deliver the package from cache and reduce the time and bandwidth required to deliver the package.

In a method for aggregating and packaging virtual content, the method includes constructing a set of commands to send to VM. The command is interpreted by VM to allocate appropriate components for the package.

The method also includes having a command interpreter on VM to interpret command and generate appropriate packages for a service. The VM automatically searches what is required for a given service and packages them for transmission to user's workstation (desktop or mobile). The command will spawn processes on VM to start search and collect components to be packaged.

The method also includes the VM checking for the security level of user and will package appropriate level of content (resolution, object types, etc.). Package that is appropriate for service with appropriate components and resolutions. The package can optionally contain CAD drawings and documents associated with the objects.

The basic input is a command from the user to retrieve package. The command contains service type, service objects, user name and authentications. The output is a package that contains complete set of objects to create service and associated documents.

Unlike other approaches where one manually searches objects for a service separately, packages these objects in a folder separately, and waits for these objects to be downloaded, certain embodiments disclosed herein automatically package objects and documents or other content with speedier downloading of the package from cache and rapid service creation.

An embodiment for a method for aggregating and packaging virtual (e.g., VR, AR, or MR) content includes requesting virtual content from a collaboration manager. The collaboration manager resides at a server, and the request comprises a command set for a display device of a requestor. The method also includes authenticating the requestor for the requested virtual content. The method also includes packaging the requested virtual content based on the command set for the display device of the requestor. The method also includes transmitting the packaged virtual content to the display device of the requestor.

The method further comprises determining if the requested virtual content exists in a cache, and transmitting the packaged virtual content from the cache.

The virtual content preferably comprises at least one of a CAD drawing, a component 3D object file, and a complete object file.

The method further comprises transmitting the packaged virtual content to a client device from the collaboration manager, and from the client device to the display device of the requestor.

In one embodiment, the display device is preferably a head mounted display.

The client device is preferably a personal computer, laptop computer, tablet computer or mobile computing device such as a smartphone.

In other embodiments, the display device is preferably selected from the group comprising a desktop computer, a laptop computer, a tablet computer, a mobile phone, an AR headset, and a virtual reality (VR) headset.

### Embodiments Relating to Creating an Immersive Virtual Sales Module

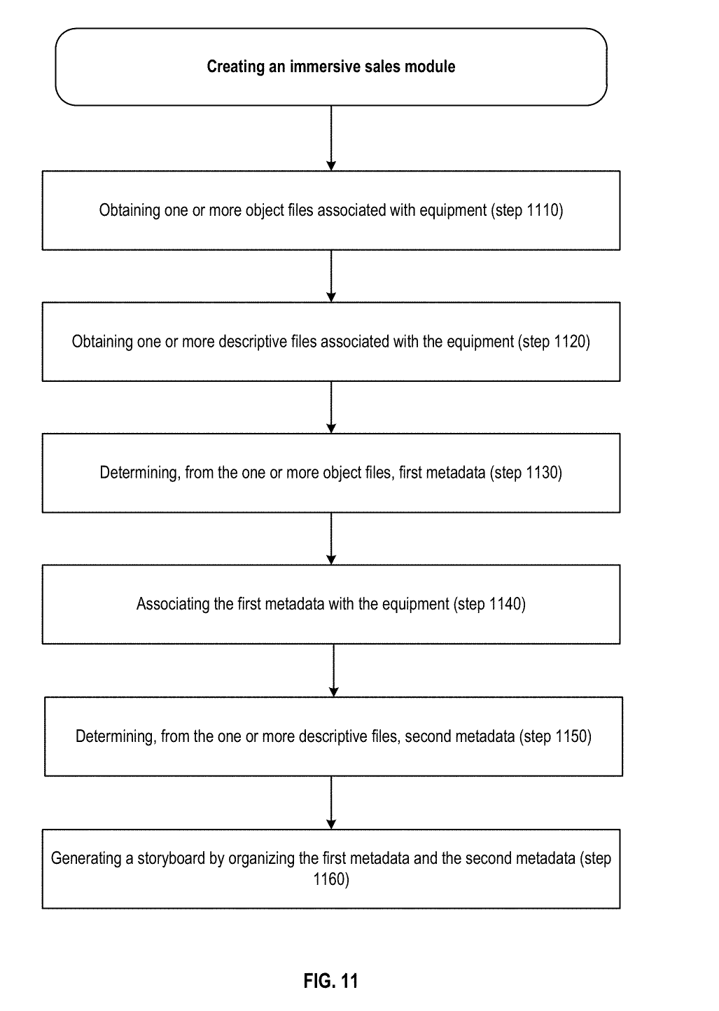

FIG. 11 depicts a method for creating an immersive virtual sales module, which comprises: obtaining one or more object files associated with equipment (step 1110); obtaining one or more descriptive files associated with the equipment (step 1120); determining, from the one or more object files, first metadata (step 1130); associating the first metadata with the equipment (step 1140); determining, from the one or more descriptive files, second metadata (step 1150); and generating a storyboard by organizing the first metadata and the second metadata (step 1160).

In one embodiment of the method depicted in FIG. 11, or of any of the embodiments of FIG. 11 disclosed herein, the one or more descriptive files include any of a specification associated with the equipment, a manual associated with the equipment, marketing materials associated with the equipment, or a computer-aided design (CAD) drawing associated with the equipment.

In one embodiment of the method depicted in FIG. 11, or of any of the embodiments of FIG. 11 disclosed herein, obtaining one or more object files associated with equipment comprises: creating a virtual representation of the equipment (e.g., based on one or more scanned images of the equipment); and storing the virtual representation of the equipment as an object file of the one or more object files.

In one embodiment of the method depicted in FIG. 11, or of any of the embodiments of FIG. 11 disclosed herein, the method further comprises: verifying the contents of the storyboard.

In one embodiment of the method depicted in FIG. 11, or of any of the embodiments of FIG. 11 disclosed herein, the method further comprises: editing the storyboard.

To create an immersive sales module for an enterprise is a manual process and not very precise. One has to take the CAD drawings, create 3D objects from those CAD drawing, extract features manually from those CAD drawing and objects, and then create a narrative. This can be a very lengthy process.

There is a need for a better way to create an immersive sales module utilizing virtual (e.g., AR/VR/MR) content. Embodiments disclosed in this section make it easier to create an immersive sales module using virtual content.

One embodiment is a method for creating an immersive virtual reality (“VR”) sales module. The method includes scanning an object for a sales module to generate a scanned object. The method also includes scanning a plurality of sub-objects for the object to generate a plurality of scanned sub-objects. The method also includes scanning a plurality of descriptive files for the object to generate a plurality of scanned descriptive files. The method also includes extracting a plurality of metadata for each of the scanned object, the plurality of scanned sub-objects, and plurality of scanned descriptive files. The method also includes utilizing an artificial intelligence program to organize the plurality of metadata with the scanned object, the plurality of scanned sub-objects, and plurality of scanned descriptive files to generate a storyboard template for a sales module. The method also includes auto-filling the storyboard template to generate a sales module for the object. The object may be equipment. The plurality of descriptive files may comprise at least one CAD files, equipment specifications, equipment manuals, and marketing documents. The method may further comprise verifying the contents of the storyboard. The method may further comprise editing the storyboard.

Another embodiment is a method for creating an immersive virtual reality (“VR”) sales module. The method includes scanning equipment, a subset of equipment, a CAD drawing, and a specification for the equipment. The method also includes extracting a plurality of first features from the scanned equipment and the subset of the equipment. The method also includes extracting a plurality of second features from the scanned CAD drawing and specification. The method also includes correlating the plurality of first features with the plurality of second features to describe an object and a plurality of features of the object. The method also includes extracting a plurality of sub-objects and a plurality of third features from the equipment using object recognition. The method also includes correlating the plurality of third features for a final equipment. The method also includes creating a storyboard for a sales module. The method may further comprise verifying the contents of the storyboard. The method may further comprise editing the storyboard.

Another embodiment is a method for creating an immersive MR sales module. The method includes scanning an object for a sales module to generate a scanned object. The method also includes scanning a plurality of sub-objects for the object to generate a plurality of scanned sub-objects. The method also includes scanning a plurality of descriptive files for the object to generate a plurality of scanned descriptive files. The method also includes extracting a plurality of metadata for each of the scanned object, the plurality of scanned sub-objects, and plurality of scanned descriptive files. The method also includes utilizing an artificial intelligence program to organize the plurality of metadata with the scanned object, the plurality of scanned sub-objects, and plurality of scanned descriptive files to generate a storyboard template for a sales module. The method also includes auto-filling the storyboard template to generate a sales module for the object. The object may be equipment. The plurality of descriptive files may comprise at least one CAD files, equipment specifications, equipment manuals, and marketing documents. The method may further comprise verifying the contents of the storyboard. The method may further comprise editing the storyboard.

Another embodiment is a method for creating an immersive MR sales module. The method includes scanning equipment, a subset of equipment, a CAD drawing, and a specification for the equipment. The method also includes extracting a plurality of first features from the scanned equipment and the subset of the equipment. The method also includes extracting a plurality of second features from the scanned CAD drawing and specification. The method also includes correlating the plurality of first features with the plurality of second features to describe an object and a plurality of features of the object. The method also includes extracting a plurality of sub-objects and a plurality of third features from the equipment using object recognition. The method also includes correlating the plurality of third features for a final equipment. The method also includes creating a storyboard for a sales module. The method may further comprise verifying the contents of the storyboard. The method may further comprise editing the storyboard.

Yet another embodiment is a method for creating an immersive AR sales module. The method includes scanning an object for a sales module to generate a scanned object. The method also includes scanning a plurality of sub-objects for the object to generate a plurality of scanned sub-objects. The method also includes scanning a plurality of descriptive files for the object to generate a plurality of scanned descriptive files. The method also includes extracting a plurality of metadata for each of the scanned object, the plurality of scanned sub-objects, and plurality of scanned descriptive files. The method also includes utilizing an artificial intelligence program to organize the plurality of metadata with the scanned object, the plurality of scanned sub-objects, and plurality of scanned descriptive files to generate a storyboard template for a sales module. The method also includes auto-filling the storyboard template to generate a sales module for the object. The object may be equipment. The plurality of descriptive files may comprise at least one CAD files, equipment specifications, equipment manuals, and marketing documents. The method may further comprise verifying the contents of the storyboard. The method may further comprise editing the storyboard.

Yet another embodiment is a method for creating an immersive AR sales module. The method includes scanning equipment, a subset of equipment, a CAD drawing, and a specification for the equipment. The method also includes extracting a plurality of first features from the scanned equipment and the subset of the equipment. The method also includes extracting a plurality of second features from the scanned CAD drawing and specification. The method also includes correlating the plurality of first features with the plurality of second features to describe an object and a plurality of features of the object. The method also includes extracting a plurality of sub-objects and a plurality of third features from the equipment using object recognition. The method also includes correlating the plurality of third features for a final equipment. The method also includes creating a storyboard for a sales module. The method may further comprise verifying the contents of the storyboard. The method may further comprise editing the storyboard.

A processor may be utilized to perform any of the methods. A downloaded application may be configured to perform any of the methods on a computing device.

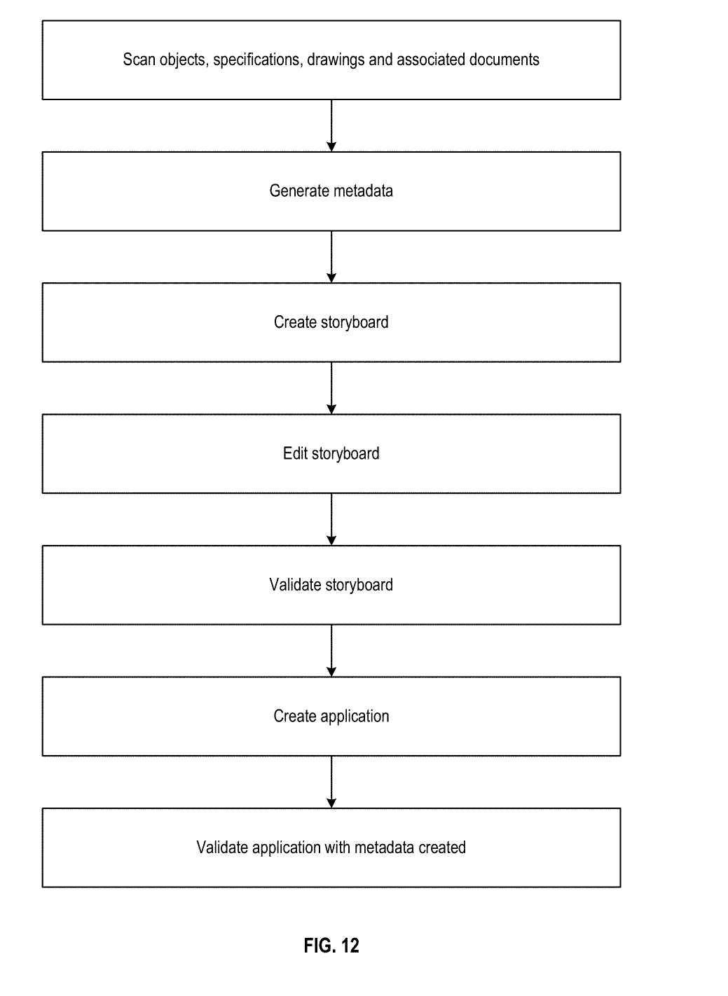

FIG. 12 is a block diagram of a method for creating an immersive sales module using virtual content.

In one embodiment, to create immersive sales experience: first scan the equipment, a subset of the equipment, the CAD drawings and/or any existing specifications/manuals; then, extract features from the scanned equipment and the subset of equipment; then, extract features from the CAD drawings and correlate them to appropriate equipment to describe the objects and its features; then, use object recognition to extract sub objects and features from the equipment; then, use these features to correlate features for the final equipment; then, use the above steps to create a storyboard for sales module. This allows one to create a sales module using the above steps, which is more accurate than manually created module.

Embodiments may include: a productivity process that automates several steps in creating immersive sales application by automating story creation (template generation), associating CAD drawings and specifications, feature extractions using metadata, sub object creation; a process to assist and semi-automate creation of sales module, associated story creation, specifications, feature description, which reduces and automates several steps in creating sales module.

Other approaches manually create storyboards, features and overall view of the sales module, and also manually check specifications, verify these specifications, storyboard and product features for the final object or assembly of objects. Embodiments in this section reduce the amount of work to create sales module, storyboards, feature explanations, verify storyboards and product features.

In one embodiment, to develop a complete sales module for a given application: first scan the equipment for which the sales module needs to be developed; scan sub objects that make up that equipment and then scan manuals and existing marketing documents that exists; scan the CAD files and specifications associated with that equipment; extract metadata associated with the equipment, drawings, specifications and sub objects; and use AI to organize this metadata and associated drawings, objects, sub objects to create a template for storyboard. The storyboard template will be auto-filled with suggested recommendations. The developer can use this storyboard either as a baseline and edit as necessary. Once the storyboard is created, user can verify the storyboards with respect to specifications, look and feel, features, etc. After this storyboard is complete, complete application is developed using this storyboard and associated objects and specifications. This increases the productivity and authenticity of sales applications.

One embodiment includes: scanning video, photo, image, web content (html, xml) to scan for metadata; scanning objects, sub objects, associated CAD drawings, specifications, and manuals to generate metadata for storyboard, and sets of features; uploading the scanned files to cloud with analytics and AI to use the scanned files to extract meta data and organize a story using AI engine; and creating a story for the sales application with the user editing the story as required and verifying all the specifications, objects using AI in cloud.

The inputs of objects files, CAD files, manuals, specifications, documents give as an output metadata and elements for storyboard. The inputs of objects and sub objects have an output of metadata associated with these objects, and associated specifications with features for these objects.

Other approaches manually read drawings, objects, sub objects, read manuals and specifications to create a story, and embodiments described herein semi-automatically create a storyboard template with story elements.

Other approaches validate a story against metadata and objects that were scanned and embodiments described herein validate storyboard elements semi-automatically.

The general elements of one embedment of the present invention include a cloud computing service; a PC, workstation, tablet, or smartphone; a display; a network—wireless or wireline; tools for creating metadata and storyboard; a database of objects, images, photos, 2D/3D rendered; documents including PowerPoint, WORD, EXCEL NOTES and KEYNOTE documents; CAD drawings.

### Embodiments Relating to Creating an Immersive Virtual Training Module

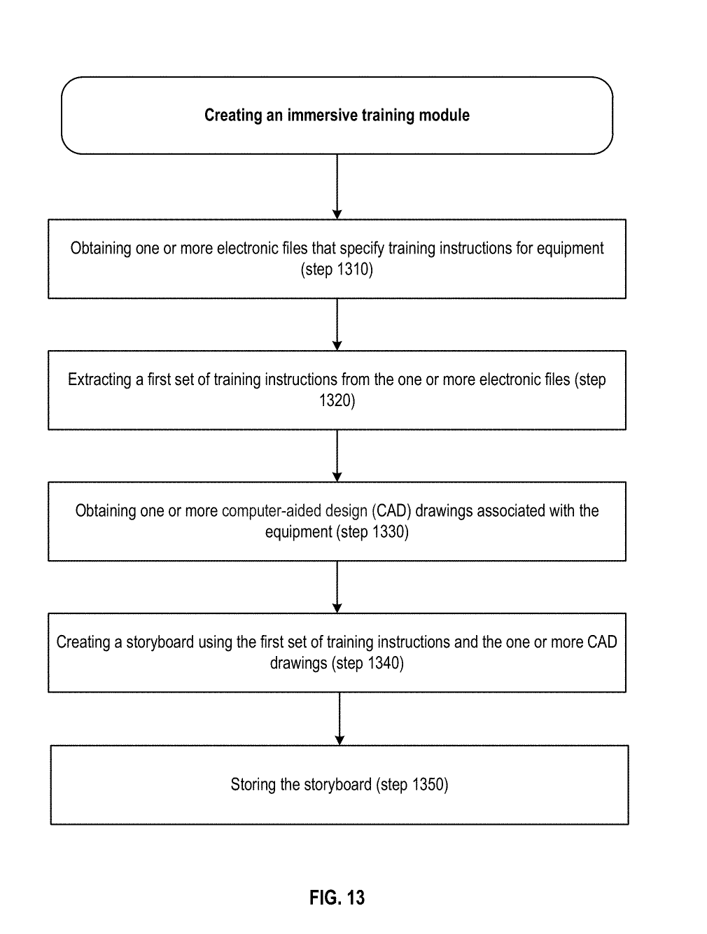

FIG. 13 depicts a method for creating an immersive training module, which comprises: obtaining one or more electronic files that specify training instructions for equipment (step 1310); extracting a first set of training instructions from the one or more electronic files (step 1320); obtaining one or more computer-aided design (CAD) drawings associated with the equipment (step 1330); creating a storyboard using the first set of training instructions and the one or more CAD drawings (step 1340); and storing the storyboard (step 1350).

In one embodiment of the method depicted in FIG. 13, additional steps may include: extracting metadata from the one or more electronic files; and storing the metadata in association with the created storyboard.

In another embodiment of the method depicted in FIG. 13, additional steps may include: extracting metadata from the one or more electronic files; determining keywords based on the metadata; and storing the keywords in association with the stored storyboard.

In one embodiment of the method depicted in FIG. 13, or of any of the embodiments of FIG. 13 disclosed herein, the one or more electronic files include any of an electronic document that includes the training instructions in a text form, a video that includes the training instructions in an audio and visual form, or an audio recording that includes the training instructions in an audio form.

In one embodiment of the method depicted in FIG. 13, or of any of the embodiments of FIG. 13 disclosed herein, the method further comprises: verifying the contents of the storyboard.

In one embodiment of the method depicted in FIG. 13, or of any of the embodiments of FIG. 13 disclosed herein, the method further comprises: editing the storyboard.

There is a need to create immersive training content, and further need to create a productivity process that (i) automates several steps in creating immersive training experience and (ii) also reduces the amount of time required to get approvals and is automatically verified against a previously approved training process.

Certain approaches rely on manual creation of training content where a person has to: (1) understand the equipment for which training is being developed; (2) read the training manual; (3) create a story board; (4) create objects from the CAD drawings; (5) create a complete training experience; (6) get approval from the customer; (7) make changes per inputs from the customer, which is a loop that can continue for several times; (8) get final approval and (9) release the resultant, final immersive training. Each step of the above approach is time consuming and very open loop.

One embodiment of this section includes a process comprising the following steps: (1) Scan training manual and extract essential training instructions and extract metadata and instructions from the training manual; (2) Scan CAD drawings required for this training; (3) Scan through a video analytics engine and extract essential metadata and voice training information. For example, in video if it states that the user should take certain action, in that case, user could be asked to do the action in a AR/VR environment and forms the basis for story and training; (4) Analyze actions from video and training manual essential story, objects and instructions and create a storyboard; (5) Tune this storyboard to create a final immersive storyboard; (6) The storyboard is compared to the training manual and video metadata automatically to ensure all essential elements of the immersive experience are captured; and (7) This is presented to the client and reduces all the loops between approval and changing the storyboard and immersive training experience, where steps 1 through 4 and 6 are automated using AI and an analytics engine, which reduces manual and any guess work that is not noted. This process becomes closed loop and reduces amount of looping required for approval.

### Additional Aspects of Embodiments Relating to Searching and Associating Virtual Content with Other Content, Aggregating and Packaging Virtual Content, Creating an Immersive Virtual Sales Module, and Creating an Immersive Virtual Training Module

User interface elements may include a capacity viewer and a mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets, communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR headsets.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human).

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

### RELATED APPLICATIONS

This application relates to the following related application(s): U.S. Pat. Appl. No. 62/515,546, filed Jun. 6, 2017, entitled METHOD AND APPARATUS FOR SEARCHING AND ASSOCIATING AR/VR CONTENT WITH OTHER CONTENT; U.S. Pat. Appl. No. 62/518,545, filed Jun. 12, 2017, entitled METHOD AND SYSTEM FOR AGGREGATING AND PACKAGING AR/VR CONTENT; and U.S. Pat. Appl. No. 62/521,481, filed Jun. 18, 2017, entitled METHOD AND SYSTEM FOR CREATING AN IMMERSIVE SALES MODULE. The content of each of the related application(s) is hereby incorporated by reference herein in its entirety.

1. A method for associating virtual objects with electronic documents, the method comprising, for each virtual object of a plurality of virtual objects:
determining metadata for the virtual object;
generating a plurality of keywords for the metadata determined for the virtual object;
determining if the plurality of keywords are associated with one or more electronic documents; and
if any of the plurality of keywords are associated with the one or more electronic documents, indexing the one or more electronic documents and the virtual object in association with each other in a searchable index.

2. The method of claim 1, further comprising: generating the searchable index to include, for each virtual object of the plurality of virtual objects, (i) the plurality of keywords generated from the metadata of the virtual object, (ii) associations between the keywords and the one or more electronic documents or associations between the keywords and the virtual object, and (iii) associations between the virtual object and the one or more electronic documents.

3. The method of claim 1, wherein determining the metadata for the virtual object comprises: using an automated program to collect the metadata from a file containing that virtual object.

4. The method of claim 1, wherein the metadata for the virtual object includes any of: an author or owner of the virtual object; a description, name or title of the virtual object; a date the virtual object was created; one or more words that represent one or more features of the virtual object; one or more images that form part of the virtual object; or one or more authors or owners of, descriptions of, names or titles of, or words that represent one or more features of one or more images that form part of the virtual object.

5. The method of claim 1, wherein generating the plurality of keywords for the metadata comprises generating as keywords any of: a name of an author or owner of the virtual object that is specified in the metadata; words from a description of the virtual object that is specified in the metadata; words from a title or name of the virtual object that is specified in the metadata; one or more words representing one or more features of the virtual object that are specified in the metadata; a name of an author or owner of an image forming part of the virtual object that is specified in the metadata; words from a description of the image forming part of the virtual object that is specified in the metadata; words from a title or name of the image forming part of the virtual object that is specified in the metadata; or one or more words representing one or more features of the image forming part of the virtual object that is specified in the metadata.

6. The method of claim 1, wherein the one or more electronic documents comprise at least a file with one or more of: text, an image, a CAD drawing, a table, a graph, a chart, a spreadsheet, a presentation, audio, or video.

7. The method of claim 1, wherein determining if the plurality of keywords are associated with one or more electronic documents comprises:
determining if metadata of the one or more electronic documents match any of the keywords;
if the metadata of the one or more electronic documents matches any of the keywords, determining that the plurality of keywords are associated with the one or more electronic documents; and
if the metadata of the one or more electronic documents does not match any of the keywords, determining that the plurality of keywords are not associated with the one or more electronic documents.

8. The method of claim 7, wherein the plurality of keywords specify a name of an author or owner of the virtual object; a description of the virtual object; a title or a name of the virtual object; or one or more words representing one or more features of the virtual object that are specified in the metadata of the virtual object.

9. The method of claim 1, further comprising:
identifying a first electronic document selected by a user;
identifying, from the searchable index, a first set of one or more virtual objects from the plurality of virtual objects that are indexed in association with the first electronic document; and
providing information about the first set of one or more virtual objects to the user.

10. The method of claim 9, wherein the provided information includes a list of the first set of one or more virtual objects, and a list of any virtual objects associated with any of the first set of one or more virtual objects.

11. The method of claim 1, further comprising:
identifying a first virtual object selected by a user;
identifying, from the searchable index, a first set of one or more electronic documents that are indexed in association with the first virtual object; and
providing information about the first set of one or more electronic documents to the user.

12. The method of claim 11, wherein the provided information includes a list of the first set of one or more electronic documents.

13. The method of claim 1, further comprising:
receiving search criteria from a user;
using the search criteria to identify, from the searchable index, a first set of one or more virtual objects from the plurality of virtual objects that are indexed in association with one or more keywords that match the search criteria; and
providing information about the first set of one or more virtual objects to the user.

14. The method of claim 1, further comprising:
receiving search criteria from a user;
using the search criteria to identify, from the searchable index, a first set of one or more electronic documents that are indexed in association with one or more keywords that match the search criteria; and
providing information about the first set of one or more electronic documents to the user.

15. The method of claim 1, wherein the virtual object is a virtual reality object, an augmented reality object, or a mixed reality object.

16. One or more non-transitory machine-readable media embodying program instructions that, when executed by one or more machines, cause the one or more machines to implement the method of claim 1.
